(19) United States
(12) Patent Application Publication
(10) Pub. No.: US 2015/0224512 A1
(43) Pub. Date: Aug. 13, 2015

(54) METHOD AND SYSTEM FOR COMMINUTING GRINDING STOCK USING A ROLLER MILL

(71) Applicant: THYSSENKRUPP INDUSTRIAL SOLUTIONS AG, Essen (DE)

(72) Inventors: Pedro Guerrero Palma, Lippetal (DE); Ludwig Könning, Ahlen (DE)

(73) Assignee: THYSSENKRUPP INDUSTRIAL SOLUTIONS AG, Essen (DE)

(21) Appl. No.: 14/415,606

(22) PCT Filed: Jul. 3, 2013
(86) PCT No.: PCT/EP2013/064043

§ 371 Date: Jan. 19, 2015

(30) Foreign Application Priority Data
Jul. 19, 2012 (DE) 10 2012 106 554.3

(51) Int. Cl. B02C 25/00; B02C 23/02; B02C 15/00

(52) U.S. Cl. CPC B02C 25/00; B02C 15/007; B02C 23/02

(57) ABSTRACT

The invention relates to a method and an apparatus for comminuting grinding stock with a roller mill, wherein a grinding plate cooperates with at least two grinding rollers and the grinding stock supplied in the mass flow is comminuted between grinding plate and grinding roller. At least two grinding rollers are driven via dedicated drives, wherein a power compensation control is carried out for the drives of the grinding rollers, such that the power of the drives is controlled in a predefined ratio to one another. The power control is then effected by changing the mass flow of the grinding stock supplied to at least one of the grinding rollers.

The invention relates to a method and an apparatus for comminuting grinding stock with a roller mill, wherein a grinding plate cooperates with at least two grinding rollers, which are driven by dedicated drives, and the grinding stock supplied in the mass flow is comminuted between grinding plate and grinding roller.

DE 197 02 854 A1 has already indicated that the individual driven grinding rollers are on one hand coupled to one another in the manner of a rotary drive via the grinding plate and the grinding stock or grinding stock bed located thereon and, on the other hand, can have very different power demands, which are for example due to different rolling diameters on the grinding plate (friction/diameter), different effective diameters of the individual grinding rollers (e.g. through wear) and a different behavior during draw-in of the grinding stock in the cooperation between grinding plate and grinding roller.

Even small changes in rotational speed between individual grinding rollers cause relatively large power variations in the individual drives. This can mean that the grinding rollers are constantly being accelerated or slowed, i.e. the individually driven grinding rollers work against one another, which leads to a substantially higher energy demand during comminuting operation.

DE 197 02 854 A1 therefore proposed equalizing the operating variations between the individual rotational drives of all the driven grinding rollers by means of a common load compensation control.

However, in the case of dynamic changes in transmission between grinding plate and grinding roller, the power demands of the drives are very different. In order to improve the compensation control, in DE 10 2007 006 092 A1 the compensation control consists of a power compensation control, wherein controlling the rotational speed of at least one drive controls the power of the drives in a predefined ratio to one another. According to DE 10 2007 041 878 B4, instead of controlling the rotational speed, the grinding pressure is controlled in order to control the power of the drives in a predefined ratio to one another.

DE 1 763 432 A further discloses a control device for a mill driven by a three-phase electric motor, for automatically controlling the supply of grinding stock for a constant load on the three-phase electric motor. EP 0 180 814 A2 discloses a roller mill with a control system in order to operate the mill over a broad throughput range, which ensures a satisfactory air-solid ratio and a desired degree of fineness.

The object of the invention was hence to develop a new concept for a power compensation control.

According to the invention, this object is achieved by virtue of the features of claims 1 and 10.

In the method according to the invention for comminuting grinding stock with a roller mill, a grinding plate cooperates with at least two grinding rollers, wherein the grinding stock supplied in the mass flow is comminuted between grinding plate and grinding roller. At least two grinding rollers are driven via dedicated drives, wherein a power compensation control is carried out for the drives of the grinding rollers, such that the power of the drives is controlled in a predefined ratio to one another. The power control is then effected by changing the mass flow of the grinding stock supplied to at least one of the grinding rollers.

The apparatus according to the invention for comminuting grinding stock with a roller mill has a grinding plate and at least two grinding rollers cooperating with the grinding plate, wherein the grinding stock supplied in the mass flow is comminuted between grinding plate and grinding roller, and wherein at least two grinding rollers have a dedicated drive and a power compensation control device for the drives of the grinding rollers is provided for controlling the power of the drives in a predefined ratio with respect to one another. The power compensation control device cooperates with at least one actuator in order to change the mass flow of the grinding stock supplied to at least one of the grinding rollers.

The term “mass flow” is understood as the material flow rate or the mass flow rate which is delivered, via a delivery device, generally onto the center of the grinding plate and is then fed to the grinding rollers. While the power compensation controls known from the prior art act directly on the grinding rollers by controlling the rotational speed or the grinding pressure, the concept according to the invention proposes, for the purpose of power compensation control, influencing the mass flow rate.

Further embodiments of the invention form the subject matter of the subclaims.

The power compensation control preferably uses the torque and/or the rotational speed of the drives as a control variable. The mass flow can in particular be changed by influencing the orientation of the mass flow with respect to the grinding roller and/or influencing the breadth of the mass flow and/or influencing the height of the mass flow and/or influencing the quantity supplied. It can also be provided to pre-compress or loosen the grinding stock supplied in the mass flow.

Further possibilities for changing the mass flow consist in changing the chemical and/or physical properties of the grinding stock. It is in particular conceivable to change the composition by adding grinding assistants and/or water and/or additives. It is also possible to add coarse material and/or fresh material and/or circulating material and/or smalls and/or finished material, in particular from a subsequent sifting process, in order to change the mass flow.

The power compensation control device is, expediently, operatively connected to torque sensors in order to detect the torque of the drives of the grinding rollers and/or to rotational speed sensors in order to detect the rotational speed of the drives of the grinding rollers, in order to then control, depending on the measurement result, at least one actuator for changing the mass flow. These actuators may for example consist of guiding elements, adjustable chutes, adjustable height limits and dosing devices.

For the drives of the grinding rollers, unregulated three-phase asynchronous electric motors are particularly suitable. The power of the drives can fundamentally be controlled such that the operating torques of the drives lie between zero and the breakdown torque of the drives. It is thus possible for the drives of the grinding rollers to be adapted to the respective grinding requirements, within a broad range.

Further advantages and embodiments of the invention are explained in more detail below with reference to the description and the drawing, in which:

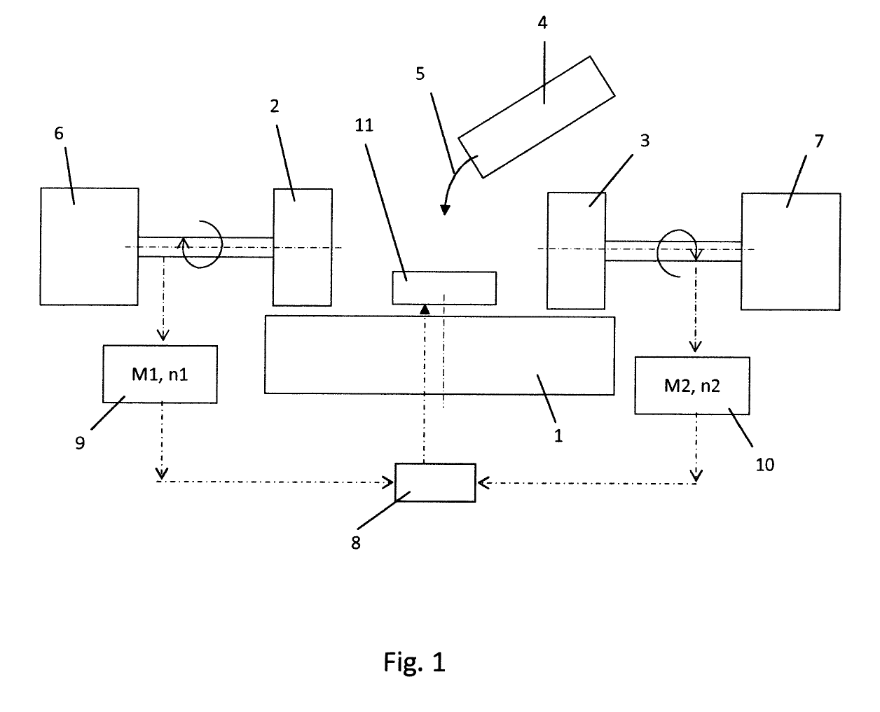

FIG. 1 is a schematic representation of an apparatus according to the invention for comminuting grinding stock with a roller mill and a power compensation control device,

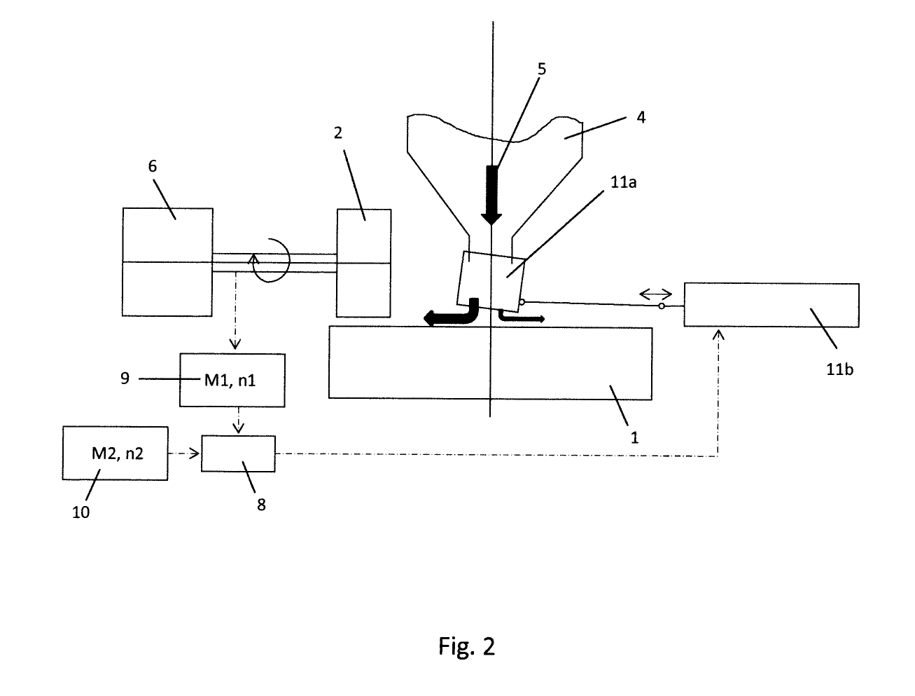

FIG. 2 shows an apparatus according to FIG. 1, wherein the power compensation control device cooperates with a pivotable chute,

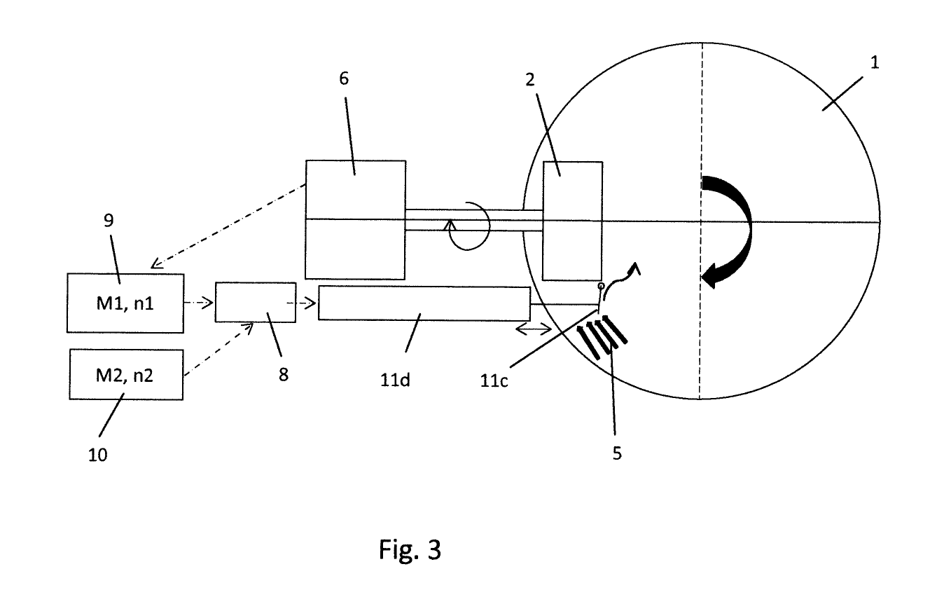

FIG. 3 shows an apparatus according to FIG. 1, wherein the power compensation control device cooperates with an adjustable guide plate,

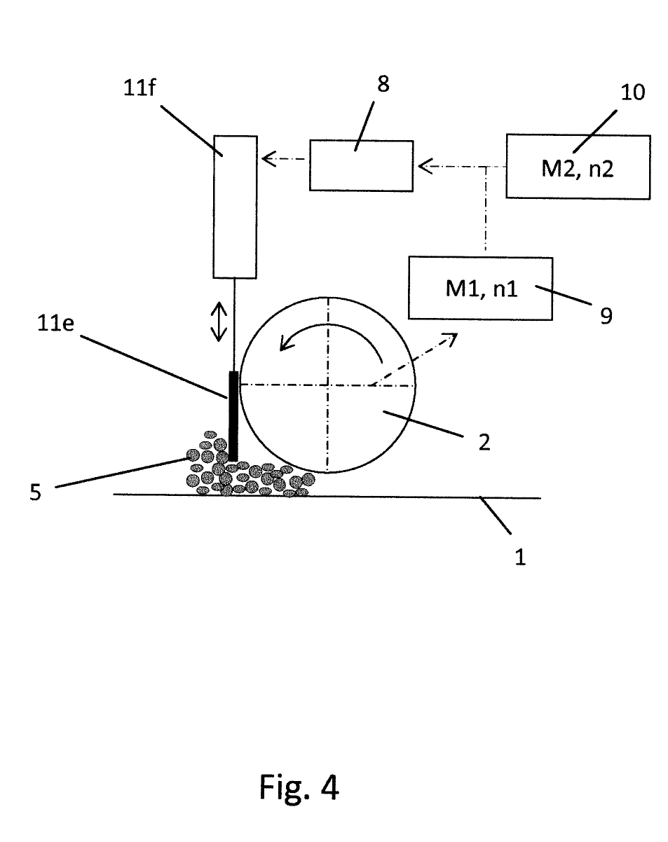

FIG. 4 shows an apparatus according to FIG. 1, wherein the power compensation control device cooperates with an adjustable height limiting element and

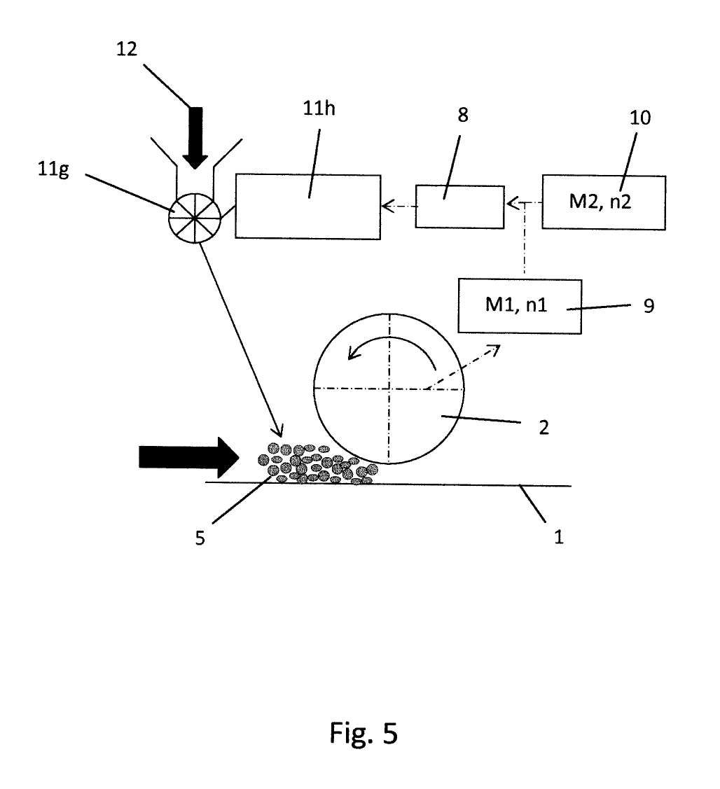

FIG. 5 shows an apparatus according to FIG. 1, wherein the power compensation control device cooperates with a device for adding additives.

The apparatus for comminuting grinding stock with a roller mill, as represented in FIG. 1, has a grinding plate 1 and at least two grinding rollers 2, 3 cooperating with the grinding plate, wherein the grinding stock 5 supplied in the mass flow via a delivery device 4 is comminuted between grinding plate and grinding roller. Each of the two grinding rollers 2, 3 has a dedicated drive 6, 7, while the grinding plate in the represented exemplary embodiment is driven via the grinding rollers 2 and 3 and the grinding stock 5 and hence no dedicated drive is assigned thereto. Within the scope of the invention, it is however also possible for the grinding plate to be additionally driven. Moreover, a power compensation control device 8 is provided, which cooperates with measuring units 9, 10 and at least one actuator 11. The measuring units 9, 10 are for example torque sensors for detecting the torque M1, M2 of the drives 6 or 7 and/or rotational speed sensors for detecting the rotational speed n1, n2 of the drives 6, 7. Using the measured values, the power compensation control device 8 can determine the power of the two drives 6, 7. The total power of all the drives is to be shared out between the individual drives in a predefined ratio. In that context, it can for example be provided that all drives are operated with the same power. It is however entirely conceivable that the powers are shared out differently, which can for example be the case with grinding rollers of different sizes.

The power compensation control device controls the power of the individual drives such that the powers lie in a predefined setpoint range. If it is established, via the measurement values (rotational speed, torque), that the power of one or other of the drives lies outside the setpoint range, the actuator 11 is used to influence, in a targeted manner, the mass flow of the grinding stock 5 supplied to at least one of the grinding rollers 2, 3. One such example might be that less grinding stock is supplied to the grinding roller whose drive power is elevated than to the grinding roller whose drive is consuming relatively too little power. It is thus possible to influence, in a targeted manner, the power of both drives 6, 7 by changing the mass flow, in order to control the power of both drives in the predefined ratio of for example 50% each.

By virtue of this control, it is not necessary for the drives 6, 7 to be equipped with expensive control devices such as frequency rectifiers. Unregulated three-phase asynchronous electric motors are thus preferably used as drives 6, 7.

The above-described apparatus is particularly suited to comminuting grinding stock such as limestone, binders and coal. The roller mill can for example be configured as follows:
diameter of the grinding plate 1: 2 m to 8 m,
diameter of the grinding roller 2, 3: 1 m to 4 m,
rated power of the drives 6, 7: 100 kW to 4000 kW.

Some exemplary embodiments for influencing the mass flow are presented in more detail below, wherein in all exemplary embodiments in each case at least two driven grinding rollers are provided. Merely for reasons of clarity, the grinding roller 3 and the associated drive 7 are not represented in the drawing. Furthermore, the same reference signs have been used for identical components.

In the exemplary embodiment according to FIG. 2, the actuator is formed by a pivotable chute 11a provided at the lower end of the delivery device 4, which chute can be made to pivot by means of an actuating drive 11b. Depending on the position of the pivotable chute 11a, the quantity of the mass flow to the two grinding rollers 2, 3 can be influenced. The power compensation control device 8 will thus control the actuating drive 11b accordingly, as a function of the measurement values determined by the measuring units 9, 10, if the powers of the two drives 6, 7 lie outside their predefined control ranges.

In the exemplary embodiment according to FIG. 3, the actuator is formed by an adjustable guide plate 11c with an associated actuating drive 11b. By means of this guide plate 11c it is in particular possible to influence the orientation of the mass flow with respect to the grinding roller and/or the breadth of the mass flow and/or the quantity supplied.

FIG. 4 shows the variant in which the mass flow is changed by influencing its height. To that end, the actuator is formed by a height limiting element 11e whose height can be set, by means of an actuating drive 11f, by the power compensation control device 8.

In the exemplary embodiment according to FIG. 5, the mass flow is influenced by changing its composition. To that end, the actuator consists of a dosing device 11g with an associated actuating drive 11h, wherein admixtures such as fresh material, circulating material or finished material, smalls, additives, water or grinding assistant are added to the grinding stock 5 by means of the dosing device 11g. If this addition is effected in a targeted manner upstream of a grinding roller, the power demand of the associated drive can be influenced in a targeted manner.

Within the context of the invention, many other possibilities for influencing the mass flow are of course conceivable. Thus, for example, what is termed a slave roller can be connected upstream of each grinding roller, which slave roller makes it possible, by means of a variable contact pressure, to pre-compress the grinding bed and thus to influence the power demand of the drives of the associated grinding rollers. It is also conceivable to loosen the grinding bed, for example by means of fluidizing air.

The abovedescribed power compensation control is on one hand very effective and is substantially more cost-effective than the rotational speed control known from the prior art.

1. A method for comminuting grinding stock (5) with a roller mill, wherein a grinding plate (1) cooperates with at least two grinding rollers (2, 3) and the grinding stock (5) supplied in the mass flow is comminuted between grinding plate (1) and grinding roller (2, 3), wherein at least two grinding rollers (2, 3) are driven via dedicated drives (6, 7) and a power compensation control is carried out for the drives (6, 7) of the grinding rollers (2, 3), such that the power of the drives (6, 7) is controlled in a predefined ratio to one another, characterized in that the power control is effected by changing the mass flow of the grinding stock (5) supplied to at least one of the grinding rollers (2, 3).

2. The method as claimed in claim 1, characterized in that the torque (M1, M2) and/or the rotational speed (n1, n2) of the drives (6, 7) is used as a control variable for the power compensation control.

3. The method as claimed in claim 1, characterized in that the mass flow is changed by influencing the orientation of the mass flow with respect to the grinding roller (2, 3) and/or influencing the breadth of the mass flow and/or influencing the height of the mass flow and/or influencing the quantity supplied.

4. The method as claimed in claim 1, characterized in that the grinding stock (5) supplied in the mass flow is pre-compressed.

5. The method as claimed in claim 1, characterized in that the grinding stock (5) supplied in the mass flow is loosened.

6. The method as claimed in claim 1, characterized in that the power of the drives (6, 7) of the grinding rollers (2, 3) is controlled such that the operating torques of the drives (6, 7) lie between zero and the breakdown torque of the drives.

7. The method as claimed in claim 1, characterized in that the mass flow is changed by changing the composition of the grinding stock (5).

8. The method as claimed in claim 7, characterized in that the mass flow is changed by adding grinding assistants and/or water and/or additives.

9. The method as claimed in claim 7, characterized in that the mass flow is changed by adding coarse material and/or fresh material and/or circulating material and/or smalls and/or finished material.

10. An apparatus for comminuting grinding stock (5) with a roller mill which has a grinding plate (1) and at least two grinding rollers (2, 3) cooperating with the grinding plate (1), wherein the grinding stock (5) supplied in the mass flow is comminuted between grinding plate (1) and grinding roller (2, 3), and wherein at least two grinding rollers have a dedicated drive (6, 7) and a power compensation control device for the drives (6, 7) of the grinding rollers (2, 3) is provided for controlling the power of the drives (6, 7) in a predefined ratio with respect to one another, characterized in that the power compensation control device (8) cooperates with at least one actuator (11) in order to change the mass flow of the grinding stock (5) supplied to at least one of the grinding rollers (2, 3).

11. The apparatus as claimed in claim 10, characterized in that the power compensation control device (8) is operatively connected to torque sensors in order to detect the torque of the drives (6, 7) of the grinding rollers and/or to rotational speed sensors in order to detect the rotational speed of the drives (6, 7) of the grinding rollers (2, 3).

12. The apparatus as claimed in claim 10, characterized in that the drives (6, 7) of the grinding rollers (2, 3) are unregulated three-phase asynchronous electric motors.
